(19) United States
(12) Patent Application Publication
(10) Pub. No.: US 2011/0079420 A1
(43) Pub. Date: Apr. 7, 2011

(54) Ceramic multilayer and method for manufacturing the same

(75) Inventors: Myung Whun CHANG, Seoul (KR); Dae Hyeong LEE, Seoul (KR); Ki Pyo HONG, Yongin-si (KR); Jin Waun KIM, Hwaseong-si (KR)

(73) Assignee: SAMSUNG ELECTRO-MECHANICS CO., LTD, Suwon (KR)

(21) Appl. No.: 12/591,735

(22) Filed: Nov. 30, 2009

(30) Foreign Application Priority Data
Oct. 1, 2009 (KR) 10-2009-0093659

(51) Int. Cl. H01R 12/06; H01R 43/00

(52) U.S. Cl. 174/262; 29/874; 29/825

(57) ABSTRACT

The present invention provides a multi-layered ceramic substrate including a first insulating sheet having a first via contact; and a second insulating sheet joined to the first insulating sheet, wherein the second insulating sheet has a second via contact aligned with the first via contact up and down to be joined to the first via contact, wherein the first via contact has a form extended to the inside of the second via contact.

### CROSS-REFERENCE TO RELATED APPLICATIONS

This application claims the benefit of Korean Patent Application No. 10-2009-0093659 filed with the Korea Intellectual Property Office on Oct. 1, 2009, the disclosure of which is incorporated herein by reference.

### BACKGROUND OF THE INVENTION

1. Field of the Invention

The present invention relates to a ceramic multi-layer; and, more particularly, to a multi-layered ceramic substrate and a manufacturing method of the same.

2. Description of the Related Art

As a manufacturing method of a conventional probe card, a Low Temperature Co-fired Ceramic (LTCC) process technology or a High Temperature Co-fired Ceramic (HTCC) process technology are widely used. According to these low and high temperature co-fired ceramic process technologies, a plurality of insulating sheets are prepared firstly, and the prepared insulating sheets are layered up and down. At this time, in each insulating sheet, a via contact and circuit wires electrically connected to the via contact are formed. Thereafter, a single multi-layered ceramic substrate is fabricated by pressuring and sintering the layered insulating sheets.

However, at the process of pressuring and sintering the insulating sheets, the via contact formed at the insulating sheet most exteriorly positioned among the insulating sheets can be pressured in direction to the outside. For instance, in the case of upward and downward pressuring the multi-layered substrate structure where the insulating sheets are layered, the via contact of the most exteriorly positioned insulating sheet is pressured in the opposite direction of the pressuring direction towards the insulating sheets. Accordingly, it occurs that the via contact formed at the most exteriorly positioned insulating sheet is protruded to the outside. If the most exterior via contact is protruded, junction reliability of the circuit wire connected to the via contact is depreciated so that electrical properties of a semiconductor device can be degraded. Also, when the multi-layered ceramic substrate is packaged, efficiency of coupling with package elements can be degraded so that reliability of a product can be depreciated.

### SUMMARY OF THE INVENTION

An object of the present invention is to provide a multi-layered ceramic substrate whose reliability is improved.

An object of the present invention is to provide a multi-layered ceramic substrate whose via contact formed at a most exteriorly positioned insulating sheet is prevented from being protruded to the outside during a manufacturing process of the multi-layered ceramic substrate.

An object of the present invention is to provide a manufacturing method of a multi-layered ceramic substrate whose reliability is improved.

An object of the present invention is to provide a manufacturing method of a multi-layered ceramic substrate whose via contact formed at a most exteriorly positioned insulating sheet is prevented from being protruded to the outside during a manufacturing process of the multi-layered ceramic substrate.

In accordance with one aspect of the present invention to achieve the object, there is provided a multi-layered ceramic substrate including a first insulating sheet having a first via contact; and a second insulating sheet joined to the first insulating sheet, wherein the second insulating sheet has a second via contact aligned with the first via contact up and down to be joined to the first via contact, wherein the first via contact has a form extended to the inside of the second via contact.

In accordance with the embodiment of the present invention, the first insulating sheet and the second insulating sheet are layered each other to form a multi-layered substrate structure, and the second insulating sheet may be positioned at the most exterior part of the multi-layered substrate structure having the first insulating sheet therebetween.

In accordance with the embodiment of the present invention, the first insulating sheet and the second insulating sheet are layered each other to form a multi-layered substrate structure, and the first insulating sheet may be positioned at the most exterior part of the multi-layered substrate structure, and the second insulating sheet is secondly positioned from the most exterior part.

In accordance with the embodiment of the present invention, the second via contact may have a high pore ratio in comparison with the first via contact.

In accordance with the embodiment of the present invention, the first via contact may include more non-contraction material in comparison with the second via contact.

In accordance with the embodiment of the present invention, the non-contraction material may include at least one of alumina, zirconia and glass.

In accordance with another aspect of the present invention to achieve the object, there is provided a multi-layered ceramic substrate including a first insulating sheet having a first via contact; and a second insulating sheet joined to the first insulating sheet, wherein the second insulating sheet has a second via contact aligned with the first via contact up and down to be joined to the first via contact, wherein the first via contact and the second via contact are formed with conductive pastes having a different contraction ratio.

In accordance with the embodiment of the present invention, the first via contact and the second via contact are joined up and down to form a junction surface, and the junction surface may have a form protruded towards the inside of the second via contact.

In accordance with the embodiment of the present invention, the second insulating sheet may be joined to at least one of a front side of the first insulating sheet and a back side which is opposite to the front side.

In accordance with the embodiment of the present invention, the first insulating sheet and the second insulating sheet are layered each other to form a multi-layered substrate structure, and the second insulating sheet may be positioned at the most exterior part of the multi-layered substrate structure having the first insulating sheet therebetween.

In accordance with the embodiment of the present invention, the first insulating sheet and the second insulating sheet are layered each other to form a multi-layered substrate structure, and the first insulating sheet is positioned at the most exterior part of the multi-layered substrate structure, and the second insulating sheet may be secondly positioned from the most exterior part.

In accordance with the embodiment of the present invention, the first via contact is formed with a first conductive paste, and the second via contact is formed with a second conductive paste having a high contraction ratio at the timing of sintering in comparison with the first conductive paste, and the first conductive paste may have a high void content in comparison with the second conductive paste.

In accordance with the embodiment of the present invention, the first via contact is formed with a first conductive paste, and the second via contact is formed with a second conductive paste having a high contraction ratio at the timing of sintering in comparison with the first conductive paste, and the first conductive paste may include more contraction material which is contracted or burned out to disappear when it is heated in comparison with the second conductive paste.

In accordance with the embodiment of the present invention, the contraction material may include polymer series material.

In accordance with the embodiment of the present invention, the first via contact is formed with a first conductive paste, and the second via contact is formed with a second conductive paste having a high contraction ratio at the timing of sintering in comparison with the first conductive paste, and the second conductive paste may include more non-contraction material which prevents contraction of a conductive particle of the second conductive paste in comparison with the first conductive paste.

In accordance with the embodiment of the present invention, the non-contraction material may include at least one of alumina, zirconia and glass.

In accordance with still another aspect of the present invention to achieve the object, there is provided a manufacturing method of a multi-layered ceramic substrate including a step of preparing a first insulating sheet having a first via contact formed with a first conductive paste; a step of preparing a second insulating sheet having a second via contact formed with a second conductive paste which has a different contraction ratio at the timing of sintering in comparison with the first conductive paste; a step of arranging the first insulating sheet and the second insulating sheet for the first via contact and the second via contact to be aligned up and down; and a step of sintering the first insulating sheet and the second insulating sheet.

In accordance with the embodiment of the present invention, the step of arranging the first insulating sheet and the second insulating sheet may include a step of joining the second insulating sheet to at least one of a front side of the front side of the first insulating sheet and a back side which is opposite to the front side.

In accordance with the embodiment of the present invention, the step of arranging the first insulating sheet and the second insulating sheet may include a step of forming a multi-layered substrate structure by layering the first insulating sheet and the second insulating sheet; and a step of joining the second insulting sheet to the first insulating sheet at the most exterior part of the multi-layered substrate structure having the first insulating sheet therebetween.

In accordance with the embodiment of the present invention, the step of arranging the first insulating sheet and the second insulating sheet may include a step of forming a multi-layered substrate structure by layering the first insulating sheet and the second insulating sheet; and a step of joining the first insulting sheet to the second insulating sheet at the most exterior part of the multi-layered substrate structure having the second insulating sheet therebetween.

In accordance with the embodiment of the present invention, the step of preparing the second insulating sheet may include a step of forming the second via hole at a second base sheet; and a step of filling the second via hole with the second conductive paste which has more void content in comparison with the first conductive paste.

In accordance with the embodiment of the present invention, the step of preparing the second insulating sheet may include a step of forming the second via hole at a second base sheet; and a step of filling the second via hole with the second conductive paste which has more contraction material which is contracted or burned out to disappear when it is heated.

In accordance with the embodiment of the present invention, the step of preparing the first insulating sheet may include a step of forming the first via hole at a first base sheet; and a step of filling the first via hole with the first conductive paste which has more non-contraction material which prevents contraction of a conductive particle of the first conductive paste at the timing of sintering in comparison with the second conductive paste.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a diagram illustrating a multi-layered ceramic substrate in accordance with an embodiment of the present invention;

FIG. 2 is a flow chart diagram illustrating a manufacturing method of the multi-layered ceramic substrate in accordance with the embodiment of the present invention;

FIGS. 3A to 3D are diagrams for explaining processes of manufacturing the multi-layered ceramic substrate in accordance with the embodiment of the present invention; and

FIG. 4 is a diagram illustrating a modified version of the multi-layered ceramic substrate in accordance with the embodiment of the present invention.

### DETAILED DESCRIPTION OF THE PREFERABLE EMBODIMENTS

Advantages and features of the present invention and a method of achieving them will be clear by referencing the accompanying drawings and the embodiments afterwards described in detail. However, the present invention is not limited by the below disclosed embodiments but can be embodied as various forms. The embodiments can be provided for completely disclosing the present invention and completely informing those skilled in the art of the scope of the present invention. Throughout the specification, the same reference numbers will be used to refer to the same elements.

The terms used in the specification are not for limiting the present invention but for explaining the embodiments. In the specification, a singular form includes a plural form unless there is a particular comment. The terms of ‘include’ and/or ‘including’ used in the specification do not exclude existence or addition of not-mentioned structure element, step, operation and/or device.

Hereinafter, a multi-layered ceramic substrate and a manufacturing method of the same are described in detail with reference to the accompanying drawings.

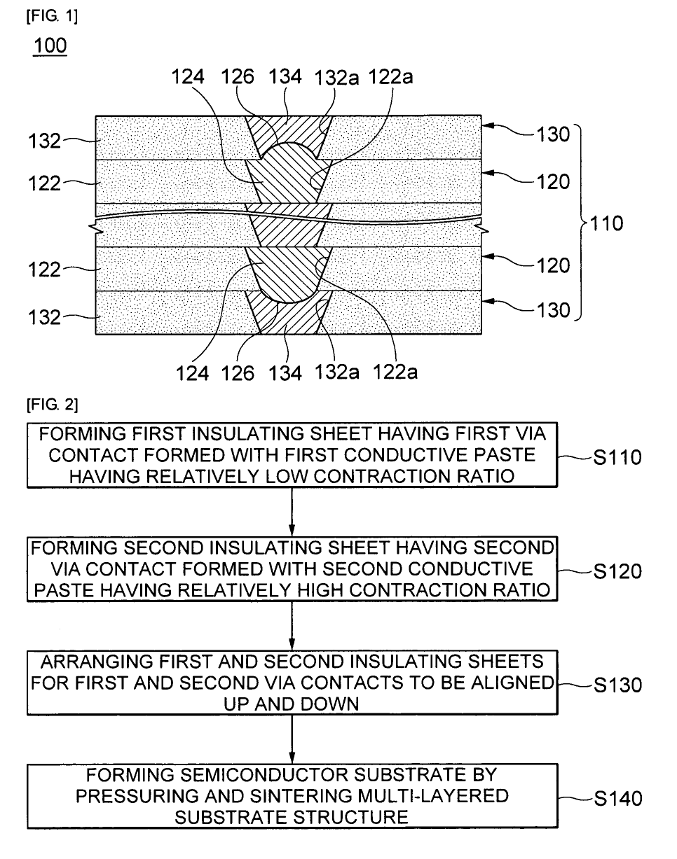

FIG. 1 is a diagram illustrating a multi-layered ceramic substrate in accordance with an embodiment of the present invention.

Referring to FIG. 1, the multi-layered ceramic substrate 100 in accordance with the embodiment of the present invention can be a multi-layered substrate manufactured in build-up method. For example, the multi-layered ceramic substrate 100 can be a Low Temperature Co-fired Ceramic (LTCC) substrate structure. For another example, the multi-layered ceramic substrate 100 can be a High Temperature Co-fired Ceramic (HTCC) substrate structure.

The multi-layered ceramic substrate 100 may have a multi-layered structure 110 where a plurality of insulating sheets is layered. For instance, the insulating sheets may include a first insulating sheet 120 and a second insulating sheet 130. The multi-layered substrate structure 110 may have a structure in which at least one of the first and second insulating sheets 120 and 130 is selectively positioned up and down.

The first insulating sheet 120 may include a first base sheet 122 having a first via hole 122a and a first via contact 124 formed at the first via hole 122a. The first base sheet 122 may be constituted with ceramic material such as polyimide. The first via contact 124 may be formed by filling the first via hole 122a with a first conductive paste. The second insulating sheet 130 may include second base sheet 132 having a second via hole 132a and a second via contact 134 formed at the second via hole 132a. The second base sheet 132 may be constituted with the ceramic material such as the polyimide. The second via contact may be formed by filling the second via hole 132a with a second conductive paste which has a different contraction ratio from the first conductive paste at the timing of sintering. In addition, the first and second insulating sheets 120 and 130 are formed on surfaces of the first and second insulating sheets 120 and 130 and may further include a circuit wire connected to the first and second via contacts 124 and 134.

The first insulating sheet 120 and the second insulating sheet 130 may be arranged so that the first via contact 124 and the second via contact 134 can face each other up and down. For instance, predetermined numbers of the first insulating sheet 120 and second insulating sheet 130 are layered, and at this time the first via contact 124 and the second via contact 134 may be aligned up and down. Accordingly, since the first via contact 124 and the second via contact 134 are positioned up and down, the multi-layered ceramic substrate 100 may have a joined structure.

As above-mentioned, since the first and second via contacts 124 and 134 are joined up and down, a junction surface 126 may be formed between the first and second via contacts 124 and 134. The junction surface 126 may have a form protruded towards the second via contact 134. For instance, the junction surface 126 may have the form protruded convexly from the first via contact 124 to the second via contact 134. Since the first via contact 124 is relatively positioned at more inner part of the multi-layered substrate structure 110 in comparison with the second via contact 134, the junction surface 126 may have the form protruded in direction to the outside of the multi-layered substrate structure 110. The junction surface 126 having this form may be formed by extending a part of the first via contact 124 towards the inside of the second via contact 134.

Meanwhile, the second via contact 134 may be formed by using the conductive paste having a higher contractility than that of the first via contact 124. For instance, the second conductive paste may have such properties that its volume is reduced if the second conductive paste is heated in comparison with the first conductive paste. For example, the second conductive paste may include higher void content in its inside in comparison with the first conductive paste. The void may be defined as empty space within the second conductive paste. Accordingly, the second conductive paste may have a porous structure. If such the second conductive paste is heated, the void parts are sintered so that a portion or all of the void parts disappear causing reduction of the volume of the second conductive paste as much as space of the void. Therefore, by controlling the second conductive paste to have more void content in comparison with the first conductive paste, the second conductive paste can have high contractibility at the timing of sintering in comparison with the first conductive paste. Accordingly, the second via contact 134 formed with the second conductive paste can have high pore ratio in comparison with the first via contact 124.

For another example, the second conductive paste may include more contraction material whose volume is reduced if it is heated in comparison with the first conductive paste. For instance, the second conductive paste may include more material whose volume is reduced or which disappears if it is heated in comparison with the first conductive paste. Polymer series material may be used as such fire-affinitive material. Accordingly, by controlling the second conductive paste to have more contraction material in comparison with the first conductive paste, the second conductive paste can have high contractibility at the timing of sintering in comparison with the first conductive paste.

For still another example, the first conductive paste may include more material whose contractibility is low in comparison with the second conductive paste. For instance, the second conductive paste may have non-contraction material which restricts movement between metal particles in comparison with the first conductive paste. Alumina, zirconia, glass or various ceramic materials can be used as the non-contraction material. Besides, the non-contraction material may include various kinds of metal material. For instance, the non-contraction material may include at least one of gold (Au), silver (Ag), palladium (Pd) and platinum (Pt). Since movement among conductive particles of the first conductive paste is restricted by the non-contraction material if the first conductive paste is heated, the contraction of the first conductive paste can be prevented. Accordingly, the first conductive paste may have low contraction ratio in comparison with the second conductive paste by being less contracted in comparison with the second conductive paste at the timing of sintering. Accordingly, the first via contact 124 formed with the first conductive paste may have more non-contraction material content in comparison with the second via contact 134. [symbol] 1, 2 conductive paste [symbol] [symbol] [symbol] [symbol] .

Continuously, the manufacturing method of the multi-layered ceramic substrate in accordance with the embodiment of the present invention is described. Herein, repeated explanations about the above-described multi-layered ceramic substrate may be omitted or shortened.

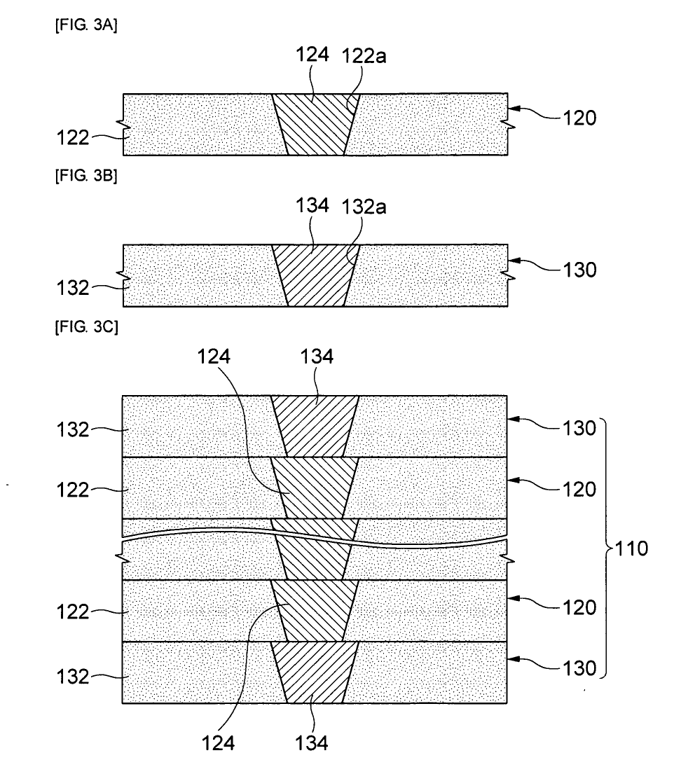

FIG. 2 is a flow chart diagram illustrating the manufacturing method of the multi-layered ceramic substrate in accordance with the embodiment of the present invention. FIGS. 3A to 3D are diagrams for explaining processes of manufacturing the multi-layered ceramic substrate in accordance with the embodiment of the present invention.

Referring to FIGS. 2 and 3A, the first insulating sheet 120 may be formed having the first via contact 124 formed with the first conductive paste having a relatively low contraction ratio (S110). For instance, the step of forming the first insulating sheet 120 may include a step of preparing the first base sheet 122 which is ceramic material; a step of forming the first via hole 122a at the first base sheet 122; and a step of filling the first via hole 122a with the first conductive paste having a relatively low contraction ratio. Accordingly, at the first insulating sheet 120, the first via contact 124 formed with the first conductive paste having a relatively low contraction ratio may be formed.

Referring to FIGS. 2 and 3B, the second insulating sheet 130 may be formed having the second via contact 134 formed with the second conductive paste having a relatively high contraction ratio (S120). For instance, the step of forming the second insulating sheet 130 may include a step of preparing the second base sheet 132 which is ceramic material; a step of forming the second via hole 132a at the second base sheet 132; and a step of filling the second via hole 132a with the second conductive paste having a relatively high contraction ratio. Accordingly, at the second insulating sheet 130, the second via contact 134 formed with the second conductive paste having a relatively high contraction ratio may be formed.

Referring to FIGS. 2 and 3C, the first and second insulating sheets 120 and 130 may be positioned so that the first via contact 124 and the second via contact 134 can be aligned up and down (S130). For instance, the first and second insulating sheets 120 and 130 may be layered so that the first via contact 124 and the second via contact 134 face each other up and down. Accordingly, predetermined unit numbers of the first and second insulating sheets 120 and 130 are layered up and down so that the multi-layered substrate structure 110 can be formed. In addition to this, the second insulating sheet 130 may be provided to be positioned at the most exterior part of the multi-layered substrate structure 110 having the first insulating sheet 120 therebetween. As a result, the multi-layered substrate structure 110 may have a structure in which each of predetermined unit numbers of the first insulating sheets 120 is inter-layered between two of the second insulating sheet 130 and the first and second via contacts 124 and 134 are layered up and down.

Referring to FIGS. 2 and 3D, the multi-layered ceramic substrate 100 can be formed by pressuring and sintering the multi-layered substrate structure 110 (S140). The step of pressuring the multi-layered substrate structure 110 can be performed by applying pressure to the multi-layered substrate structure 110 in direction of up and down so that the first and second insulating sheets 120 and 130 are compressed. At the step of sintering the multi-layered substrate structure 110, the first and second insulating sheets 120 and 130 can be joined by sintering the multi-layered substrate structure 110 in an equal or higher temperature than a melting point of the first and second via contacts 124 and 134. The above-mentioned step of pressuring the multi-layered substrate structure 110 and step of sintering the multi-layered substrate structure 110 may be simultaneously performed.

Meanwhile, at the steps of pressuring up and down and sintering the first and second insulating sheets 120 and 130, the second via contact 134 formed at the second insulating sheet 130 may be pressured in direction to the outside. Particularly, in the case where the first via contact 124 and the second via contact 134 are layered up and down, if the first and second insulating sheets 120 and 130 are compressed, a portion of the first via contact 124 is extended to the second via contact 134 so that the second via contact 134 may be pushed towards the outside by the first via contact 124. At this time, since the second via contact 134 has a relatively high contraction ratio at the timing of pressuring and sintering, the second via contact 134 can accommodate the extended part of the first via contact 124. Accordingly, the second via contact 134 can be prevented from being protruded to the outside by accommodating the extended part of the first via contact 124 by being contracted when the multi-layered substrate 110 is pressured and sintered and the part of the first via contact 124 is extended to the second via contact 134. Accordingly, the junction surface 126 between the first and second via contacts 124 and 134 may have a form protruded towards the second via contact 134. Herein, the contracting rate of the second via contact 134 may be adjusted considering the extending rate of the first via contact 124. Accordingly, the void content and the contraction material content of the second conductive paste may be adjusted, or the non-contraction material content of the first conductive paste may be adjusted for adjusting the contraction ratio of the second via contact 134 considering the extending rate of the first via contact 124.

As above-mentioned, the multi-layered ceramic substrate 100 in accordance with the embodiment of the present invention may have the multi-layered substrate structure 110 constituted with the first and second insulating sheets 120 and 130 formed with the conductive pastes having different contraction ratios at the timing of sintering. The multi-layered substrate structure 110 can prevent the protrusion phenomenon of the via contact positioned at the most exteriorly layered insulating sheet by the second via contact 134 formed with the conductive paste having a relatively high contraction ratio at the timing of pressuring and sintering. Accordingly, the multi-layered ceramic substrate 100 in accordance with the present invention can improve the junction reliability of the via contact and the product reliability.

Also, the manufacturing method of the multi-layered ceramic substrate in accordance with the present invention may include the step of preparing the first and second insulating sheets 120 and 130 formed with the conductive pastes having different contraction ratios; the step of forming the multi-layered substrate structure 110 by layering the first and second insulating sheets 120 and 130; and the step of pressuring and sintering the multi-layered substrate structure 110. At the step of pressuring and sintering the multi-layered substrate structure 110, the protrusion phenomenon of the via contact positioned at the most exteriorly layered insulating sheet can be prevented by the second via contact 134 formed with the conductive paste having a relatively high contraction ratio. Accordingly, the manufacturing method of the multi-layered ceramic substrate in accordance with the present invention makes it possible to manufacture the multi-layered ceramic substrate 100 capable of improving the junction reliability of the via contact and the product reliability.

Hereinafter, a modified version of the multi-layered ceramic substrate in accordance with the embodiment of the present invention is described in detail. Herein, repeated explanations about the above-described multi-layered ceramic substrate 100 may be omitted or shortened. Also, since the manufacturing method of the multi-layered ceramic substrate in accordance with the modified version can be fully deduced from the above-described manufacturing method of the multi-layered ceramic substrate 100 by those skilled in the art, detailed explanations about this are omitted.

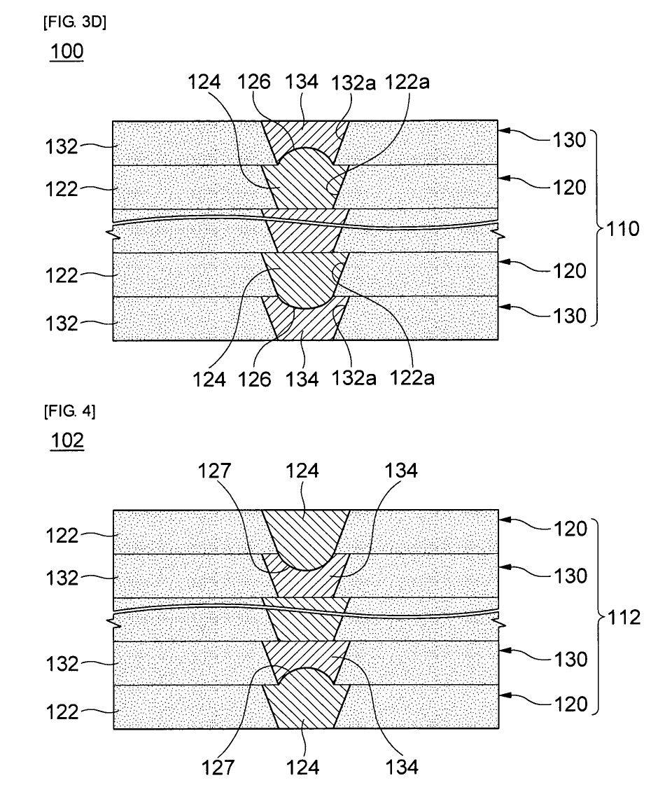

FIG. 4 is a diagram illustrating the modified version of the multi-layered ceramic substrate in accordance with the embodiment of the present invention.

Referring to FIG. 4, the multi-layered ceramic substrate 102 in accordance with the modified version of the present invention may include a multi-layered substrate structure 112 where the first insulating sheet 120 and the second insulating sheet 130 are layered. The first and second insulating sheets 120 and 130 have the substantially same structures as the first and second insulating sheets 120 and 130 explained referring to FIG. 1, and detailed explanations about this are omitted.

Meanwhile, the multi-layered substrate structure 112 may be provided with the first and second insulating sheets 120 and 130 positioned for the first via contact 124 and the second via contact 134 to be layered up and down. Herein, the first insulating sheet 120 may be positioned at the most exterior part of the multi-layered substrate structure 112, and the second insulating sheet 130 may be positioned next to the most exterior part of the multi-layered substrate structure 112. Accordingly, the first via contact 124 is positioned at the most exterior part and the second via contact 134 is more innerly positioned in comparison with the first via contact 124 so that the second via contact 134 can be joined to the first via contact 124. Accordingly, the junction surface 127 may be formed between the first via contact 124 and the second via contact 134. The junction surface 127 may have a form protruded towards the second via contact 134. For instance, the junction surface 127 may have a form convexly protruded towards the second via contact 134. Since the first via contact 124 is relatively positioned at more outer part of the multi-layered substrate structure 110 in comparison with the second via contact 134, the junction surface 127 may have the form protruded in direction to the inside of the multi-layered substrate structure 110. The junction surface 127 having this form may be formed by extending a part of the first via contact 124 to the inside of the second via contact 134.

In comparison with the multi-layered ceramic substrate 100 explained referring to FIG. 1, the above-mentioned multi-layered ceramic substrate 102 may have a structure where the first insulating sheet 120 is positioned at the most exterior part of the multi-layered substrate structure 112 and the second insulating sheet 130 is secondly positioned from the most exterior part. The multi-layered ceramic substrate 102 having this structure can prevent the protrusion phenomenon of the first via contact 124 positioned at the most exterior part of the multi-layered substrate structure 112 by accommodating the extended part of the first via contact 124 by the second via contact 134 formed with the second conductive paste having a relatively high contraction ratio at the timing of pressuring and sintering the multi-layered substrate structure 112. Accordingly, the multi-layered ceramic substrate 102 in accordance with the present invention can improve the junction reliability of the via contact and the product reliability.

The multi-layered ceramic substrate in accordance with the present invention may have the multi-layered substrate structure constituted with the insulating sheets having the via contacts formed with the conductive pastes having different contraction ratios at the timing of sintering. The multi-layered substrate structure can prevent the protrusion phenomenon of the via contact positioned at the most exteriorly layered insulating sheet by the via contact formed with the conductive paste having a relatively high contraction ratio at the timing of pressuring and sintering. Accordingly, the multi-layered ceramic substrate in accordance with the present invention can improve the junction reliability of the via contact and the product reliability.

The manufacturing method of the multi-layered ceramic substrate in accordance with the present invention may include the step of preparing the insulating sheets formed with the conductive pastes having different contraction ratios; the step of forming the multi-layered substrate structure by layering the insulating sheets; and the step of pressuring and sintering the multi-layered substrate structure. At the step of pressuring and sintering the multi-layered substrate structure, the protrusion phenomenon of the via contact positioned at the most exteriorly layered insulating sheet can be prevented by the via contact formed with the conductive paste having a relatively high contraction ratio. Accordingly, the manufacturing method of the multi-layered ceramic substrate in accordance with the present invention makes it possible to manufacture the multi-layered ceramic substrate 100 capable of improving the junction reliability of the via contact and the product reliability.

Although the present invention has been described with respect to the specific embodiments, it will be apparent to those skilled in the art that various changes and modifications may be made without departing from the spirit and scope of the invention as defined in the following claims.

1. A multi-layered ceramic substrate, comprising:
a first insulating sheet having a first via contact; and
a second insulating sheet joined to the first insulating sheet, wherein the second insulating sheet has a second via contact aligned with the first via contact up and down to be joined to the first via contact,
wherein the first via contact has a form extended to the inside of the second via contact.

2. The multi-layered ceramic substrate of claim 1, wherein the first insulating sheet and the second insulating sheet are layered each other to form a multi-layered substrate structure, and the second insulating sheet is positioned at the most exterior part of the multi-layered substrate structure having the first insulating sheet therebetween.

3. The multi-layered ceramic substrate of claim 1, wherein the first insulating sheet and the second insulating sheet are layered each other to form a multi-layered substrate structure, and the first insulating sheet is positioned at the most exterior part of the multi-layered substrate structure, and the second insulating sheet is secondly positioned from the most exterior part.

4. The multi-layered ceramic substrate of claim 1, wherein the second via contact has a high pore ratio in comparison with the first via contact.

5. The multi-layered ceramic substrate of claim 1, wherein the first via contact includes more non-contraction material in comparison with the second via contact.

6. The multi-layered ceramic substrate of claim 5, wherein the non-contraction material includes at least one of alumina, zirconia and glass.

7. A multi-layered ceramic substrate, comprising:
a first insulating sheet having a first via contact; and
a second insulating sheet joined to the first insulating sheet, wherein the second insulating sheet has a second via contact aligned with the first via contact up and down to be joined to the first via contact,
wherein the first via contact and the second via contact are formed with conductive pastes having a different contraction ratio.

8. The multi-layered ceramic substrate of claim 7, wherein the first via contact and the second via contact are joined up and down to form a junction surface, and the junction surface has a form protruded towards the inside of the second via contact.

9. The multi-layered ceramic substrate of claim 7, wherein the second insulating sheet is joined to at least one of a front side of the first insulating sheet and a back side which is opposite to the front side.

10. The multi-layered ceramic substrate of claim 7, wherein the first insulating sheet and the second insulating sheet are layered each other to form a multi-layered substrate structure, and the second insulating sheet is positioned at the most exterior part of the multi-layered substrate structure having the first insulating sheet therebetween.

11. The multi-layered ceramic substrate of claim 7, wherein the first insulating sheet and the second insulating sheet are layered each other to form a multi-layered substrate structure, and the first insulating sheet is positioned at the most exterior part of the multi-layered substrate structure, and the second insulating sheet is secondly positioned from the most exterior part.

12. The multi-layered ceramic substrate of claim 7, wherein the first via contact is formed with a first conductive paste, and the second via contact is formed with a second conductive paste having a high contraction ratio at the timing of sintering in comparison with the first conductive paste, and the first conductive paste has a high void content in comparison with the second conductive paste.

13. The multi-layered ceramic substrate of claim 7, wherein the first via contact is formed with a first conductive paste, and the second via contact is formed with a second conductive paste having a high contraction ratio at the timing of sintering in comparison with the first conductive paste, and the first conductive paste includes more contraction material which is contracted or burned out to disappear when it is heated in comparison with the second conductive paste.

14. The multi-layered ceramic substrate of claim 13, wherein the contraction material includes polymer series material.

15. The multi-layered ceramic substrate of claim 7, wherein the first via contact is formed with a first conductive paste, and the second via contact is formed with a second conductive paste having a high contraction ratio at the timing of sintering in comparison with the first conductive paste, and the second conductive paste includes more non-contraction material which prevents contraction of a conductive particle of the second conductive paste in comparison with the first conductive paste.

16. The multi-layered ceramic substrate of claim 15, wherein the non-contraction material includes at least one of alumina, zirconia and glass.

17. A manufacturing method of a multi-layered ceramic substrate, comprising:
preparing a first insulating sheet having a first via contact formed with a first conductive paste;
preparing a second insulating sheet having a second via contact formed with a second conductive paste which has a different contraction ratio at the timing of sintering in comparison with the first conductive paste;
arranging the first insulating sheet and the second insulating sheet for the first via contact and the second via contact to be aligned up and down; and
sintering the first insulating sheet and the second insulating sheet.

18. The manufacturing method of the multi-layered ceramic substrate of claim 17, wherein arranging the first insulating sheet and the second insulating sheet includes joining the second insulating sheet to at least one of a front side of the front side of the first insulating sheet and a back side which is opposite to the front side.

19. The manufacturing method of the multi-layered ceramic substrate of claim 17, wherein arranging the first insulating sheet and the second insulating sheet includes:
forming a multi-layered substrate structure by layering the first insulating sheet and the second insulating sheet; and
joining the second insulting sheet to the first insulating sheet at the most exterior part of the multi-layered substrate structure having the first insulating sheet therebetween.

20. The manufacturing method of the multi-layered ceramic substrate of claim 17, wherein arranging the first insulating sheet and the second insulating sheet includes:
forming a multi-layered substrate structure by layering the first insulating sheet and the second insulating sheet; and
joining the first insulting sheet to the second insulating sheet at the most exterior part of the multi-layered substrate structure having the second insulating sheet therebetween.

21. The manufacturing method of the multi-layered ceramic substrate of claim 17, wherein preparing the second insulating sheet includes:
forming the second via hole at a second base sheet; and
filling the second via hole with the second conductive paste which has more void content in comparison with the first conductive paste.

22. The manufacturing method of the multi-layered ceramic substrate of claim 17, wherein preparing the second insulating sheet includes:
forming the second via hole at a second base sheet; and
filling the second via hole with the second conductive paste which has more contraction material which is contracted or burned out to disappear when it is heated.

23. The manufacturing method of the multi-layered ceramic substrate of claim 17, wherein preparing the first insulating sheet includes:
forming the first via hole at a first base sheet; and
filling the first via hole with the first conductive paste which has more non-contraction material which prevents contraction of a conductive particle of the first conductive paste at the timing of sintering in comparison with the second conductive paste.
